(19) United States
(12) Patent Application Publication
(10) Pub. No.: US 2026/0188918 A1
(43) Pub. Date: Jul. 2, 2026

(54) CONNECTOR ASSEMBLY AND CABLE-END CONNECTOR

(71) Applicant: Bellwether Electronic Corp., Taoyuan City (TW)

(72) Inventor: Chih-Ming TSAI, Taoyuan City (TW)

(21) Appl. No.: 19/424,144

(22) Filed: Dec. 18, 2025

Related U.S. Application Data
(60) Provisional application No. 63/739,128, filed on Dec. 27, 2024.

(51) Int. Cl. H01R 4/48

(52) U.S. Cl. CPC H01R 4/4809

(57) ABSTRACT

A connector assembly includes a busbar clip (BBC) connector, a plurality of cable-end connectors, a plurality of first conductive connecting pieces and a plurality of second conductive connecting pieces. The first conductive connecting pieces are connected with one of the cable-end connectors and a side of the BBC connector. The second conductive connecting pieces are connected with another one of the cable-end connectors and another side of the BBC connector. The BBC connector and the cable-end connectors are respectively configured to be connected with a chassis.

### RELATED APPLICATIONS

This application claims priority to U.S. Provisional Application Ser. No. 63/739,128, filed Dec. 27, 2024, which is herein incorporated by reference in its entirety.

### BACKGROUND

### Technical Field

The present disclosure relates to connector assemblies and cable-end connectors installed therein, and particularly to connector assemblies and cable-end connectors capable of transmitting a relatively large current.

### Description of Related Art

As the pace of modern life continues to accelerate, the demand for electronic devices has been steadily increasing. Facing to a huge consumer market, manufacturers focus not only on enhancing the functionality and performance of their products but also striving to improve the reliability and stability of electronic devices in order to boost the market competitiveness of their products.

Taking power connectors as an example, the measure to, at a low cost, effectively reduce their size to save space, while increasing usage flexibility and allowing higher current to flow safely, is undoubtedly an important issue that the industry highly concerns about and also a goal that needs urgent improvement in the related field.

### SUMMARY

A technical aspect of the present disclosure is to provide a connector assembly, which can optimize overall space utilization while maintaining high current flow.

According to an embodiment of the present disclosure, a connector assembly includes a busbar clip (BBC) connector, a plurality of cable-end connectors, a plurality of first conductive connecting pieces and a plurality of second conductive connecting pieces. The first conductive connecting pieces are connected with one of the cable-end connectors and a side of the BBC connector. The second conductive connecting pieces are connected with another one of the cable-end connectors and another side of the BBC connector. The BBC connector and the cable-end connectors are respectively configured to be connected with a chassis.

According to an embodiment of the present disclosure, a connector assembly includes a cable-end connector and a board-end connector. The cable-end connector includes a first housing, a plurality of first terminals, a plurality of conductive connecting pieces and a plurality of guiding pins. The first housing has a plurality of openings, a first side and a second side opposite to the first side. The openings are located at the first side. The first terminals are configured to be inserted from the second side and at least partially located in the first housing. The first terminals are aligned with the openings. The conductive connecting pieces are connected with the first terminals. The guiding pins are connected with the first housing and extend from the first side. Each of the guiding pins has a semi-circular cross-section. The board-end connector includes a second housing, a structural frame and a plurality of second terminals. The second housing is configured to be mounted on a circuit board. The structural frame is connected outside the second housing and defines a mating space therein. The mating space is configured to at least partially accommodate the first housing. The structural frame has a plurality of guiding grooves communicated with the mating space and configured to accommodate the guiding pins. The second terminals respectively have a central portion, a plug end and a board end. The central portion is located in the second housing. The plug end and the board end respectively protrude outside the second housing. The board end is configured to be electrically connected with the circuit board. The plug end is located in the mating space and configured to pass through one of the openings to electrically connect with a corresponding one of the first terminals.

According to an embodiment of the present disclosure, a cable-end connector includes a first housing, a plurality of terminals, a stopping structure and a plurality of conductive connecting pieces. The first housing includes a main shell and an isolation wall. The main shell has an accommodation space, a latching hole, a plurality of first openings and a plurality of second openings. The isolation wall is disposed in the main shell and divides the accommodation space into two sub-accommodation spaces. The second openings are respectively larger than the first openings. The first openings are opposite to the second openings. Each of the sub-accommodation spaces is communicated with one of the first openings and a corresponding one of the second openings. The terminals are respectively accommodated in one of the sub-accommodation spaces. Each of the terminals has a cavity aligned with a corresponding one of the first openings and configured to accommodate a crown spring. The stopping structure is configured to at least partially pass through the latching hole and at least partially interfere with the terminals, so as to fix the terminals relative to the first housing. The conductive connecting pieces respectively have a first end and a second end opposite to the first end. The first end is connected with a busbar clip (BBC) connector. The second end is connected with one of the terminals.

### BRIEF DESCRIPTION OF THE DRAWINGS

The disclosure can be more fully understood by reading the following detailed description of the embodiments, with reference made to the accompanying drawings as follows:

FIG. 1 is a schematic view of a connector assembly according to an embodiment of the present disclosure;

FIGS. 2-3 are schematic views of the connector assembly of FIG. 1 as viewed from different angles, in which the chassis and the board-end connector are omitted;

FIGS. 4-5 are schematic views of the connector assembly of FIGS. 2-3 as viewed from different angles, in which the housings of the cable-end connector and the busbar clip (BBC) connector are omitted;

FIGS. 6-7 are schematic enlarged views of the cable-end connector of FIG. 1 as viewed from different angles;

FIG. 8 is an exploded view of the cable-end connector of FIGS. 6-7;

FIG. 9 is a sectional view along the sectional line A-A of FIG. 6;

FIGS. 10a-10b are schematic enlarged views of the stopping structure of FIG. 9 as viewed from different angles;

FIGS. 11a-11b are schematic enlarged views of the board-end connector of FIG. 1 as viewed from different angles; and

FIG. 12 is a sectional view along the sectional line B-B of FIG. 11a.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

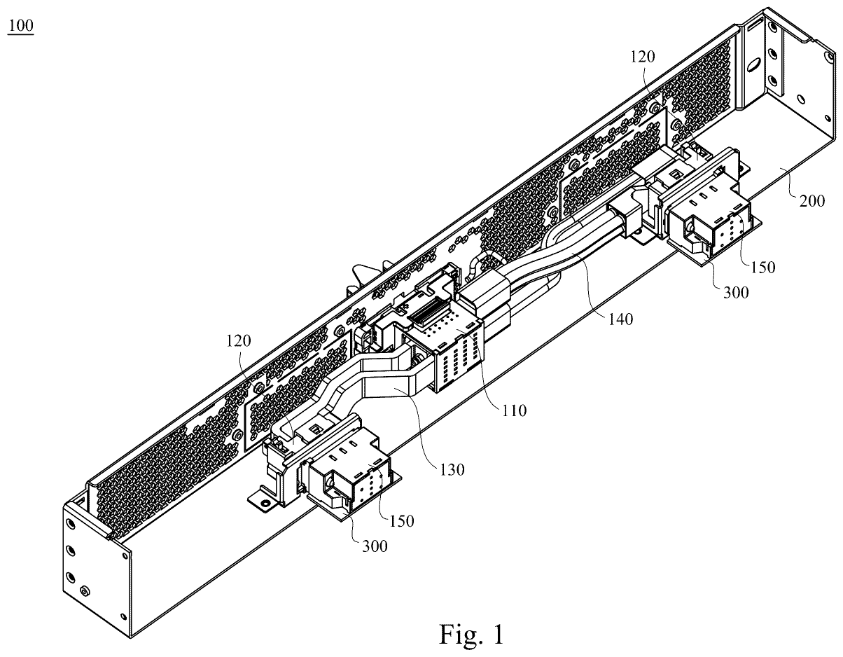

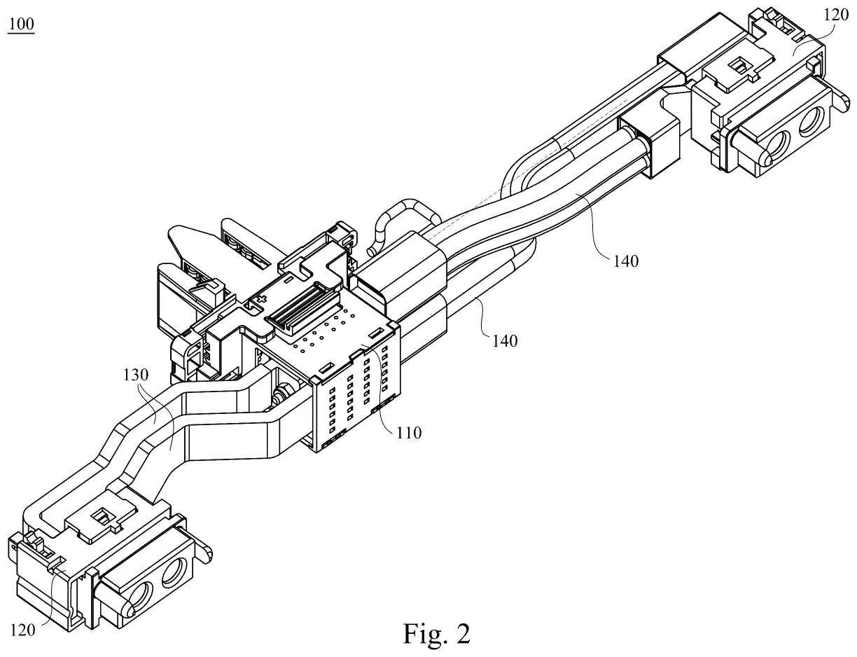

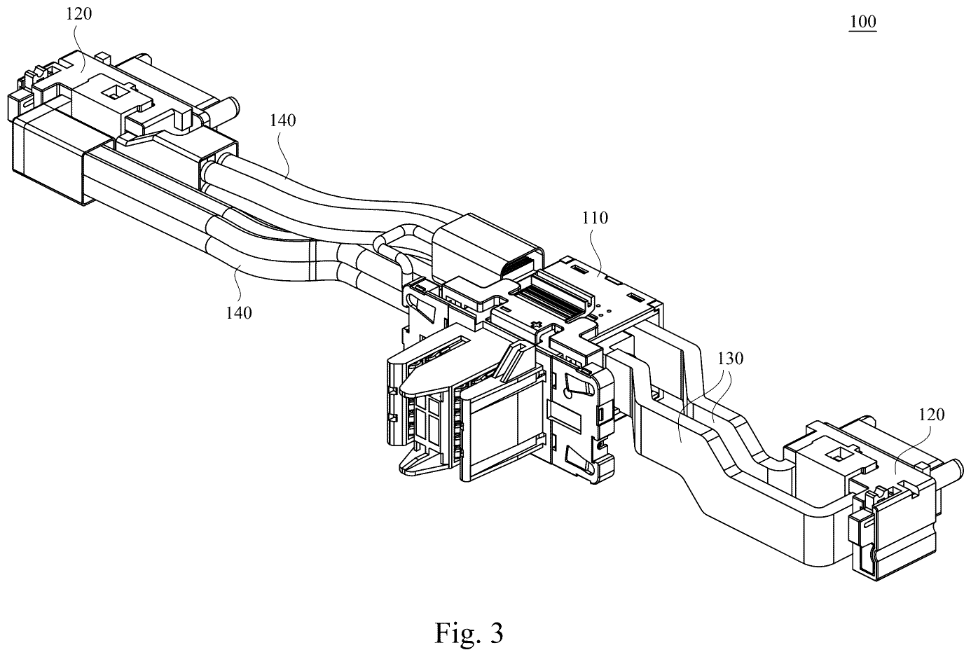

Please refer to FIGS. 1-3. In this embodiment, as shown in FIGS. 1-3, a connector assembly 100 includes a busbar clip (BBC) connector 110, a plurality of cable-end connectors 120, a plurality of first conductive connecting pieces 130, a plurality of second conductive connecting pieces 140 and a plurality of board-end connectors 150. The first conductive connecting pieces 130 are electrically isolated from each other and connect with one of the cable-end connectors 120 and a side of the BBC connector 110. The second conductive connecting pieces 140 are electrically isolated from each other and connect with another one of the cable-end connectors 120 and another side of the BBC connector 110, i.e., the first conductive connecting pieces 130 and the second conductive connecting pieces 140 are connected to opposite sides of the BBC connector 110. The BBC connector 110 and the cable-end connectors 120 are respectively configured to be connected to a chassis 200. For the sake of drawing simplification, only a portion of the chassis 200 is shown in FIG. 1. In practice, the chassis 200 may be, for example, a server chassis. The board-end connectors 150 are respectively connected with a circuit board 300 and configured to be pluggably connected with the cable-end connectors 120. In practical applications, the circuit board 300 may be printed circuit boards separated from each other. In other embodiments, depending on actual situations, the circuit board 300 may be the same piece of printed circuit board, i.e., the board-end connectors 150 are connected with the same piece of printed circuit board 300.

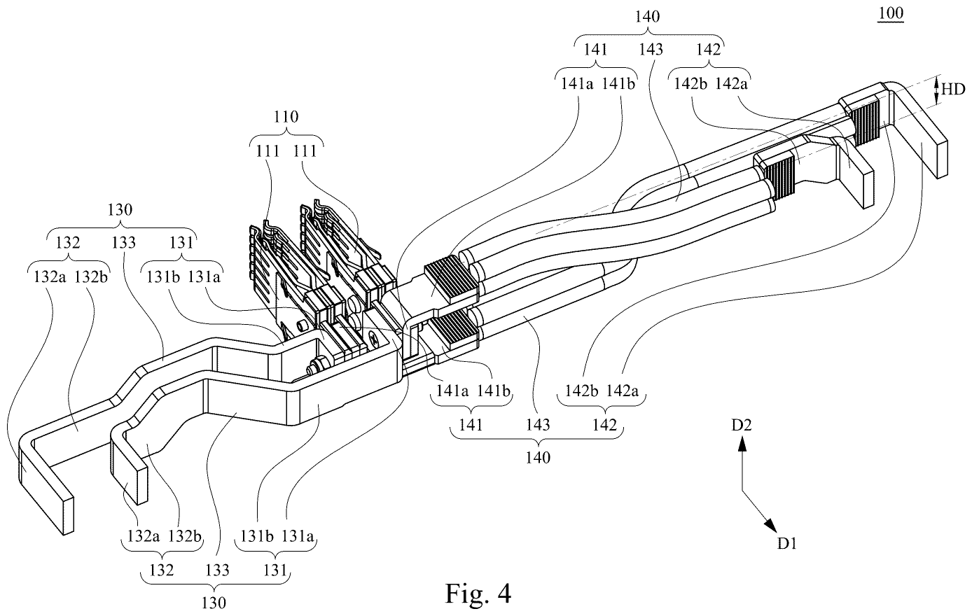

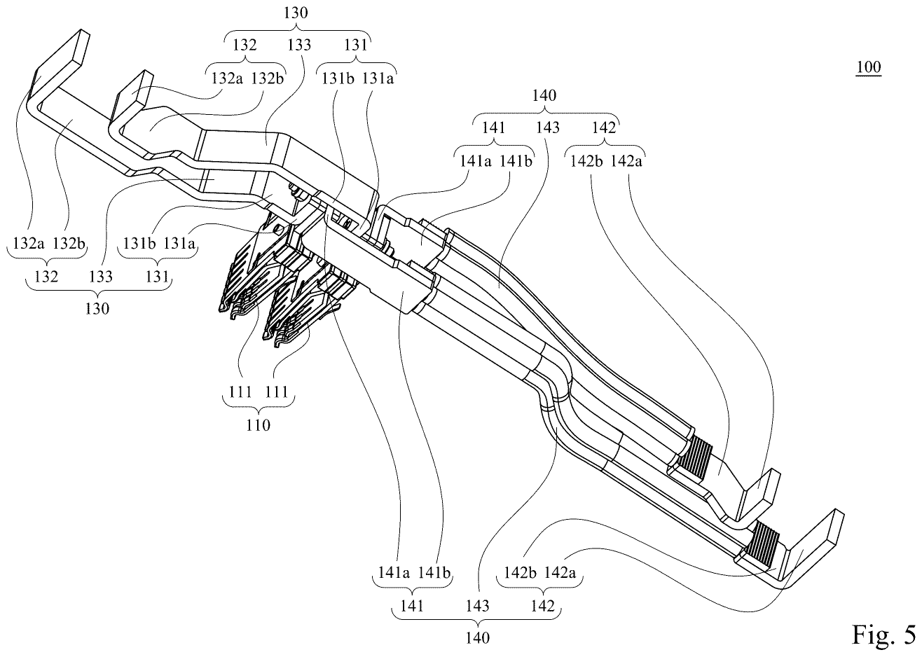

Please refer to FIGS. 4-5. In this embodiment, as shown in FIGS. 4-5, the first conductive connecting pieces 130 respectively include a first connecting section 131, a second connecting section 132 and a first extension section 133. The first connecting section 131 includes a first sub-connecting section 131a and a second sub-connecting section 131b connected with the first sub-connecting section 131a. The first sub-connecting section 131a is bent relative to the second sub-connecting section 131b and connected with the BBC connector 110. The second sub-connecting section 131b is connected with an end of the first extension section 133. In practice, the first sub-connecting section 131a is perpendicularly bent relative to the second sub-connecting section 131b, and the first sub-connecting sections 131a of different first conductive connecting pieces 130 are parallel with each other. The second connecting section 132 includes a third sub-connecting section 132a and a fourth sub-connecting section 132b connected with the third sub-connecting section 132a. The third sub-connecting section 132a is bent relative to the fourth sub-connecting section 132b and connected with one of the cable-end connectors 120. The fourth sub-connecting section 132b is connected with another end of the first extension section 133. In practice, the third sub-connecting section 132a is perpendicularly bent relative to the fourth sub-connecting section 132b, and the third sub-connecting sections 132a of different first conductive connecting pieces 130 are parallel with each other. Moreover, for example, the first sub-connecting section 131a is also parallel with the third sub-connecting section 132a.

Similarly, the second conductive connecting piece 140 respectively include a third connecting section 141, a fourth connecting section 142 and a second extension section 143. The third connecting section 141 includes a fifth sub-connecting section 141a and a sixth sub-connecting section 141b connected with the fifth sub-connecting section 141a. The fifth sub-connecting section 141a is bent relative to the sixth sub-connecting section 141b and connected with the BBC connector 110. The sixth sub-connecting section 141b is connected to an end of the second extension section 143. In practice, the fifth sub-connecting section 141a is perpendicularly bent relative to the sixth sub-connecting section 141b, and the fifth sub-connecting sections 141a of different second conductive connecting pieces 140 are parallel with each other. The fourth connecting section 142 includes a seventh sub-connecting section 142a and an eighth sub-connecting section 142b connected with the seventh sub-connecting section 142a. The seventh sub-connecting section 142a is bent relative to the eighth sub-connecting section 142b and connected to another one of the cable-end connectors 120. The eighth sub-connecting section 142b is connected to another end of the second extension section 143. In practice, the seventh sub-connecting section 142a is perpendicularly bent relative to the eighth sub-connecting section 142b, and the seventh sub-connecting sections 142a of different second conductive connecting pieces 140 are parallel with each other. Moreover, for example, the fifth sub-connecting section 141a is also parallel with the seventh sub-connecting section 142a.

For example, as shown in FIGS. 4-5, the first extension section 133 of each of the first conductive connecting pieces 130 is a busbar, and the second extension section 143 of each of the second conductive connecting pieces 140 is a cable bundle.

In other embodiments, both the first extension section 133 of each of the first conductive connecting pieces 130 and the second extension section 143 of each of the second conductive connecting pieces 140 may be busbars, or both the first extension section 133 and the second extension section 143 may be cable bundles.

Furthermore, depending on actual situations, the first extension section 133 of at least one of the first conductive connecting pieces 130 may be a busbar, while the first extension section 133 of at least another one of the first conductive connecting pieces 130 is a cable bundle, i.e., the plurality of first conductive connecting pieces 130 are a hybrid combination of busbars and cable bundles. Similarly, the plurality of second conductive connecting pieces 140 may also be a hybrid combination of busbars and cable bundles.

In practical applications, when the first extension section 133 or the second extension section 143 is a busbar, this busbar may be rigid or flexible. A rigid busbar has relatively high rigidity and is not easily deformed, whereas a flexible busbar has certain flexibility and is relatively easily deformed. Moreover, when the first extension section 133 or the second extension section 143 is a busbar, the first conductive connecting piece 130 or the second conductive connecting piece 140 is at least partially covered by a plastic heat-shrink tube to provide protection to the first conductive connecting piece 130 or the second conductive connecting piece 140 and optimize electrical isolation between the first conductive connecting pieces 130 or the second conductive connecting pieces 140.

In practice, the first connecting section 131, the second connecting section 132, the third connecting section 141 and the fourth connecting section 142 are all rigid busbar structures. Therefore, when both the first extension section 133 and the second extension section 143 are rigid busbars, the first conductive connecting piece 130 and the second conductive connecting piece 140 are integrally formed rigid busbar structures.

In addition, for example, when the first extension section 133 or the second extension section 143 is a flexible busbar, this flexible busbar may be a flexible laminated busbar or a flexible braided copper busbar. A flexible laminated busbar is formed by stacking multiple thin copper foils or other conductive materials, while a flexible braided copper busbar is woven from multiple strands of fine copper wires.

Since the first conductive connecting pieces 130 and the second conductive connecting pieces 140 are respectively connected between the BBC connector 110 and the cable-end connectors 120, and the first extension section 133 of each of the first conductive connecting pieces 130 and the second extension section 143 of each of the second conductive connecting pieces 140 may be a busbar or a cable bundle (with busbars being rigid or flexible), a user can flexibly adjust the mounting positions of the BBC connector 110 and the cable-end connectors 120 on the chassis 200 while maintaining high current flowing through the first connecting pieces 130 and the second conductive connecting pieces 140, thereby optimizing space utilization of the connector assembly 100 in the chassis 200.

Furthermore, as shown in FIGS. 4-5, the BBC connector 110 includes a plurality of terminal sets 111 which are electrically isolated from each other. In this embodiment, the first sub-connecting section 131a of one of the first conductive connecting pieces 130 and the fifth sub-connecting section 141a of one of the second conductive connecting pieces 140 are connected with one of the terminal sets 111, while the first sub-connecting section 131a of another one of the first conductive connecting pieces 130 and the fifth sub-connecting section 141a of another one of the second conductive connecting pieces 140 are connected with another one of the terminal sets 111. In other words, at least one of the first sub-connecting sections 131a is located between fifth sub-connecting sections 141a, and at least one of the fifth sub-connecting sections 141a is located between first sub-connecting sections 131a. This means the first conductive connecting pieces 130 and the second conductive connecting pieces 140 are alternately connected to different terminal sets 111 of the BBC connector 110, which helps improve routing flexibility when the cable-end connectors 120 are connected to the BBC connector 110. Moreover, the first sub-connecting sections 131a of the first conductive connecting pieces 130 are substantially parallel with the fifth sub-connecting sections 141a of the second conductive connecting pieces 140.

Furthermore, in this embodiment, the second sub-connecting section 131b of one of the first conductive connecting pieces 130 and the second sub-connecting section 131b of another one of the first conductive connecting pieces 130 are arranged along a first direction D1, while the sixth sub-connecting section 141b of one of the second conductive connecting pieces 140 and the sixth sub-connecting section 141b of another one of the second conductive connecting pieces 140 are arranged along a second direction D2, in which the first direction D1 and the second direction D2 are different from each other. This means the first direction D1 and the second direction D2 are intersected with each other as an angle such as 45°, 90°, or 135°. In this way, the second sub-connecting sections 131b of the first conductive connecting pieces 130 and the sixth sub-connecting sections 141b of the second conductive connecting pieces 140 are offset from each other, preventing mutual interference between the first conductive connecting pieces 130 and the second conductive connecting pieces 140.

In other embodiments, the first sub-connecting section 131a of one of the first conductive connecting pieces 130 and the first sub-connecting section 131a of another one of the first conductive connecting pieces 130 are connected with one of the terminal sets 111, while the fifth sub-connecting section 141a of one of the second conductive connecting pieces 140 and the fifth sub-connecting section 141a of another one of the second conductive connecting pieces 140 are connected with another one of the terminal sets 111, i.e., the first conductive connecting pieces 130 and the second conductive connecting pieces 140 are respectively connected to different terminal sets 111 of the BBC connector 110.

As mentioned above, in this embodiment, the second extension section 143 of each of the second conductive connecting pieces 140 is a cable bundle. As shown in FIG. 4, two opposite ends of the second extension section 143 of at least one of the second conductive connecting pieces 140 have a height difference HD in the second direction D2, so that the fourth connecting sections 142 of the plurality of second conductive connecting pieces 140 can be at the same height level in the second direction D2, facilitating connection between the second conductive connecting pieces 140 and the cable-end connector 120.

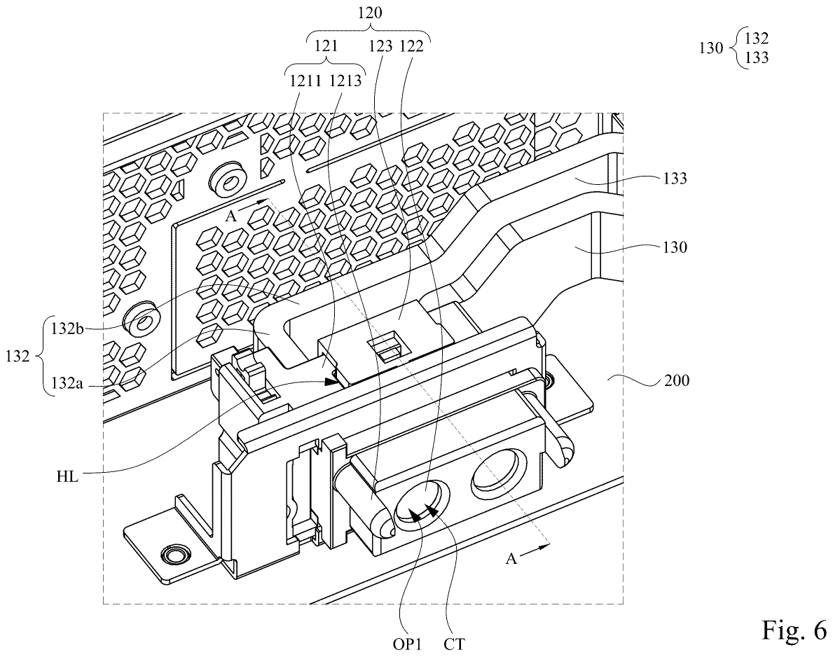

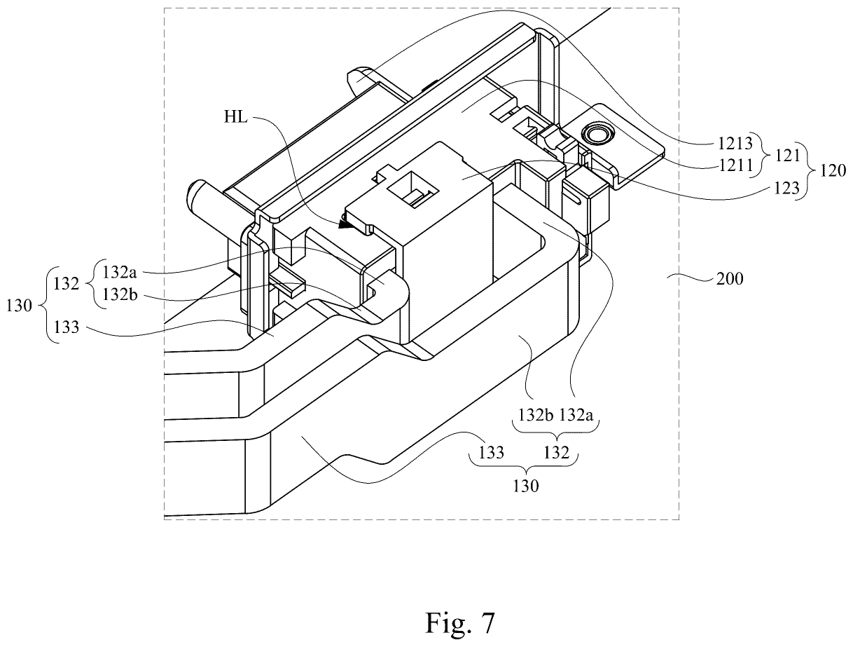

Please refer to FIGS. 6-8. In this embodiment, as shown in FIGS. 6-8, the cable-end connectors 120 respectively include a first housing 121, a plurality of terminals 122 and a stopping structure 123. The first housing 121 includes a main shell 1211 and an isolation wall 1212. The main shell 1211 has an accommodation space SP, a latching hole HL, a plurality of first openings OP1 and a plurality of second openings OP2. The isolation wall 1212 is disposed in the main shell 1211 and divides the accommodation space SP into two sub-accommodation spaces SP′. The second opening OP2 are respectively larger than the first openings OP1. The first openings OP1 are opposite to the second openings OP2. Each of the sub-accommodation spaces SP′ is communicated with one of the first openings OP1 and a corresponding one of the second openings OP2. The terminals 122 are respectively accommodated in the sub-accommodation spaces SP′. Each of the terminals 122 has a cavity CT and a latching groove GL. The cavity CT is aligned with a corresponding one of the first openings OP1 and configured to accommodate a crown spring (not shown). The stopping structure 123 is latched to the first housing 121 and at least partially blocks the second openings OP2 to prevent the terminals 122 from being loosened from the sub-accommodation spaces SP′ through the second openings OP2.

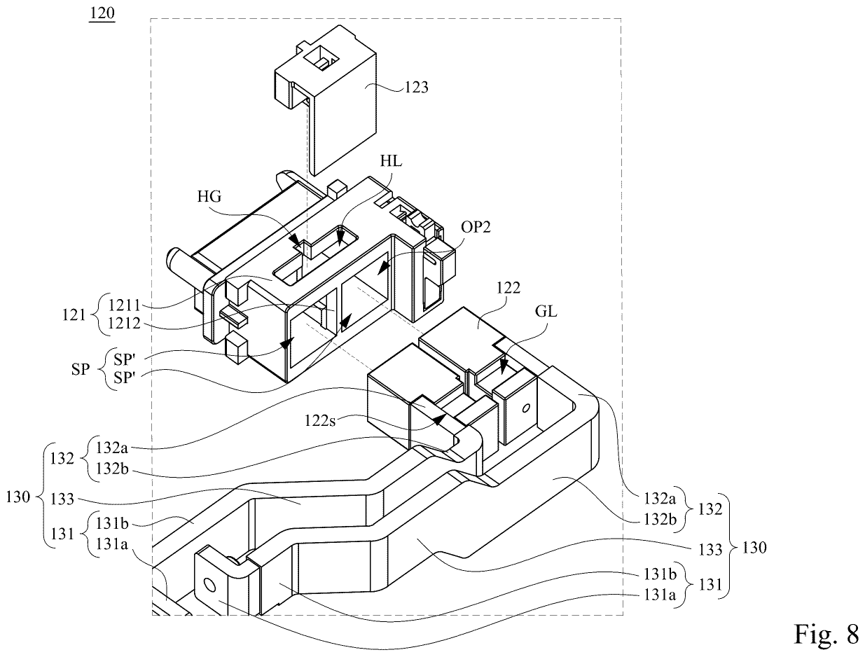

It is worth to note that, as shown in FIG. 8, each of the terminals 122 is at least partially recessed on a side away from another one of the terminals 122 to form an abutting surface 122s. The third sub-connecting section 132a of the first conductive connecting piece 130 passes through the second opening OP2 and at least partially abuts against the abutting surface 122s, which effectively reduces the overall width after the third sub-connecting section 132a is connected with the terminal 122, enabling space savings. Similarly, the seventh sub-connecting section 142a of the second conductive connecting piece 140 may also pass through the second opening OP2 of another one of the cable-end connectors 120 and at least partially abut against the abutting surface 122s of the terminal 122, and details are not repeated here.

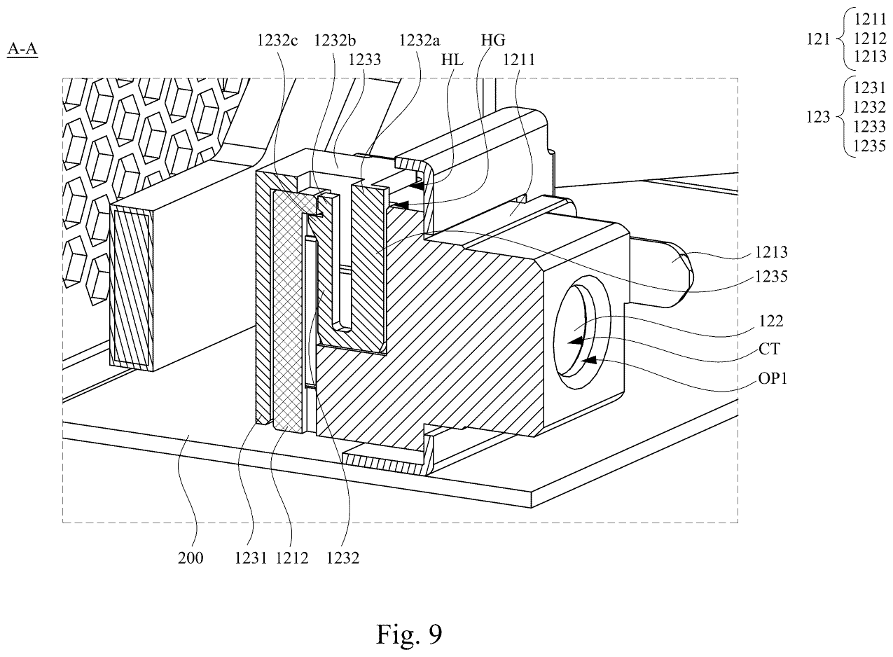

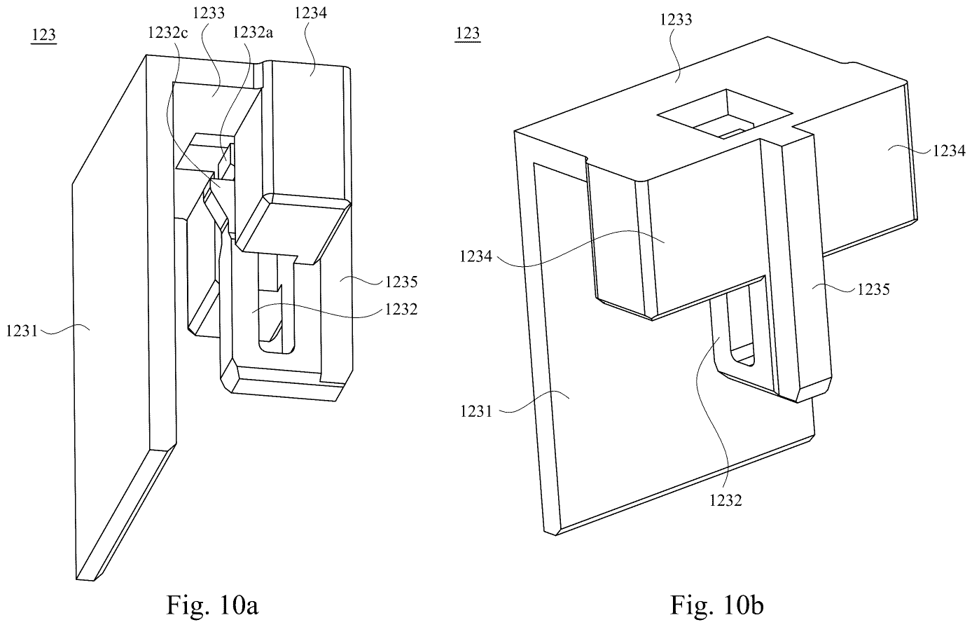

Please refer to FIGS. 9, 10a, and 10b. To be specific, as shown in FIGS. 9, 10a and 10b, the stopping structure 123 includes a baffle plate 1231, a U-shaped resilient arm 1232, a cover plate 1233 and a plurality of latching portions 1234. The baffle plate 1231 at least partially blocks the second openings OP2 of the main shell 1211. The U-shaped resilient arm 1232 has a fixed end 1232a, a free end 1232b and a barb portion 1232c. The free end 1232b is closer to the baffle plate 1231 than the fixed end 1232a. The barb portion 1232c is disposed at the free end 1232b. The cover plate 1233 is connected with the baffle plate 1231 and the fixed end 1232a and configured to abut against the main shell 1211. The latching portions 1234 are connected with the baffle plate 1231 and two opposite sides of the fixed end 1232a. The latching portions 1234 and the U-shaped resilient arm 1232 are configured to at least partially pass through the latching hole HL of the main shell 1211. The latching portions 1234 are at least partially located in the latching grooves GL of the terminals 122 (please see FIG. 8 for the latching grooves GL) to fix the position of the terminals 122 relative to the first housing 121. The U-shaped resilient arm 1232 is aligned with the isolation wall 1212. After passing through the latching hole HL of the main shell 1211, the barb portion 1232c is latched onto the main shell 1211 to prevent the stopping structure 123 from detaching from the first housing 121.

Furthermore, as shown in FIG. 9, the main shell 1211 of the cable-end connector 120 further has a guiding hole HG. The guiding hole HG is communicated with the latching hole HL. Correspondingly, as shown in FIGS. 9, 10a and 10b, the stopping structure 123 further includes a guiding strip 1235. The guiding strip 1235 is disposed on a side of the fixed end 1232a of the U-shaped resilient arm 1232 away from the free end 1232b and configured to pass through the guiding hole HG to guide the process of the latching portions 1234 and the U-shaped resilient arm 1232 passing through the latching hole HL.

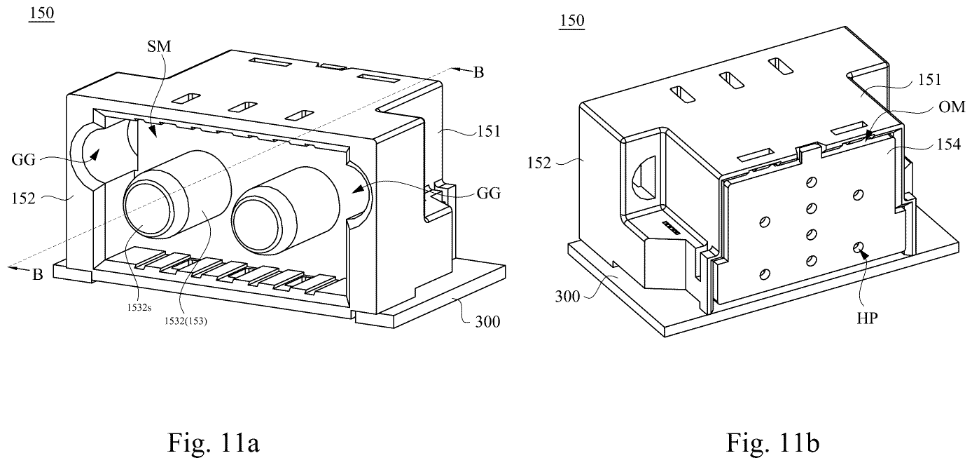

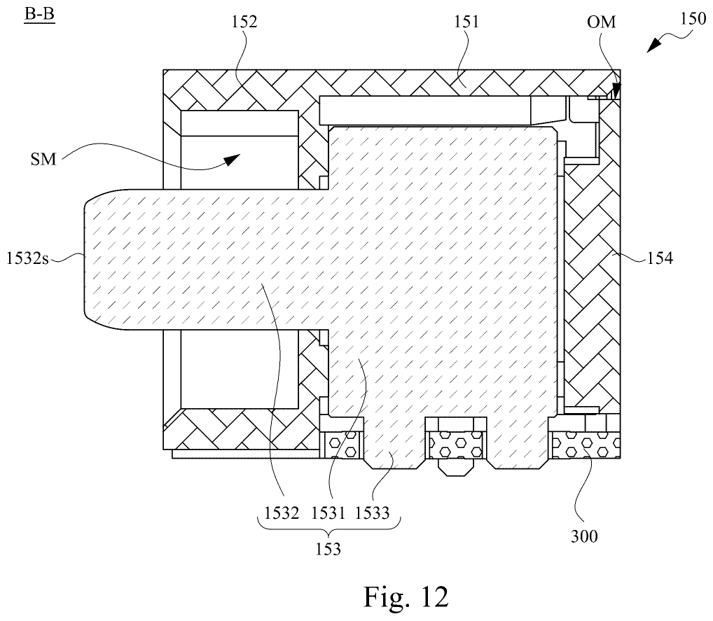

Please refer to FIGS. 11a, 11b and 12. In this embodiment, as shown in FIGS. 11a, 11b and 12, the board-end connector 150 includes a second housing 151, a structural frame 152, a plurality of terminals 153 and a rear cover 154. The second housing 151 is configured to be mounted on the circuit board 300. The structural frame 152 is connected outside the second housing 151 and defines a mating space SM therein. The mating space SM is configured to at least partially accommodate the main shell 1211 of the cable-end connector 120. The structural frame 152 has a plurality of guiding grooves GG. The guiding grooves GG are communicated with the mating space SM. The terminals 153 respectively have a central portion 1531, a plug end 1532 and a board end 1533. The central portion 1531 is located in the second housing 151. The plug end 1532 and the board end 1533 respectively protrude outside the second housing 151. The board end 1533 is configured to be electrically connected with the circuit board 300. The plug end 1532 is located in the mating space SM and configured to pass through the first opening OP1 of the cable-end connector 120 and the cavity CT of the terminal 122 (please see FIGS. 5 and 8 for the first opening OP1 and the cavity CT) to electrically connect with the crown spring inside the terminal 122. The plug end 1532 is substantially columnar. Furthermore, as shown in FIGS. 5-6, the first housing 121 of the cable-end connector 120 further includes a plurality of guiding pins 1213. Each of the guiding pins 1213 has a semi-circular cross-section. The guiding pins 1213 are connected with the main shell 1211 and extend in a direction away from the second openings OP2. The guiding pins 1213 with semi-circular cross-sections provide better structural strength while saving space. The guiding pins 1213 of the cable-end connector 120 are configured to be accommodated in the guiding grooves GG of the board-end connector 150, facilitating at least partial insertion of the cable-end connector 120 into the mating space SM of the board-end connector 150 and enabling the plug ends 1532 of the board-end connector 150 to electrically connect with the crown springs inside the terminals 122. The second housing 151 has a mounting opening OM. The mounting opening OM is located on a side of the second housing 151 away from the structural frame 152. The rear cover 154 is disposed on the second housing 151 to cover the mounting opening OM and has a plurality of heat dissipation holes HP for heat dissipation of the board-end connector 150.

It is worth to note that, as shown in FIG. 12, the plug end 1532 of the terminal 153 has a flat surface 1532s. The flat surface 1532s is located on a side of the plug end 1532 away from the central portion 1531, which effectively increases the contact area with the crown spring inside the terminal 122 when inserted, thereby optimizing electrical connection between the cable-end connector 120 and the board-end connector 150.

In conclusion, the aforementioned embodiments of the present disclosure have at least the following advantages:
(1) Since the first conductive connecting pieces and the second conductive connecting pieces are respectively connected between the BBC connector and the cable-end connectors, and the first extension section of each of the first conductive connecting pieces and the second extension section of each of the second conductive connecting pieces may be a busbar or a cable bundle (with busbars being rigid or flexible), a user can flexibly adjust the mounting positions of the BBC connector and the cable-end connectors on the chassis while maintaining high current flowing through the first connecting pieces and the second conductive connecting pieces, thereby optimizing space utilization of the connector assembly in the chassis.
(2) Since each of the terminals is at least partially recessed on a side away from another one of the terminals to form an abutting surface, while one of the third sub-connecting section of the first conductive connecting piece and the seventh sub-connecting section of the second conductive connecting piece passes through the second opening and at least partially abuts against the abutting surface, which effectively reduces the overall width after the third sub-connecting section and the seventh sub-connecting section is connected with the terminal, enabling space savings.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A connector assembly, comprising:
a busbar clip (BBC) connector;
a plurality of cable-end connectors;
a plurality of first conductive connecting pieces connecting with one of the cable-end connectors and a side of the BBC connector; and
a plurality of second conductive connecting pieces connecting with another one of the cable-end connectors and another side of the BBC connector,
wherein the BBC connector and the cable-end connectors are respectively configured to be connected with a chassis.

2. The connector assembly of claim 1, wherein the first conductive connecting pieces respectively comprise a first connecting section, a second connecting section and a first extension section, the first connecting section comprises a first sub-connecting section and a second sub-connecting section connected with the first sub-connecting section, the first sub-connecting section is bent relative to the second sub-connecting section and connected with the BBC connector, the second sub-connecting section is connected with an end of the first extension section, the second connecting section comprises a third sub-connecting section and a fourth sub-connecting section connected with the third sub-connecting section, the third sub-connecting section is bent relative to the fourth sub-connecting section and connected with one of the cable-end connectors, the fourth sub-connecting section is connected with another end of the first extension section, the second conductive connecting pieces respectively comprise a third connecting section, a fourth connecting section and a second extension section, the third connecting section comprises a fifth sub-connecting section and a sixth sub-connecting section connected with the fifth sub-connecting section, the fifth sub-connecting section is bent relative to the sixth sub-connecting section and connected with the BBC connector, the sixth sub-connecting section is connected to an end of the second extension section, the fourth connecting section comprises a seventh sub-connecting section and an eighth sub-connecting section connected with the seventh sub-connecting section, the seventh sub-connecting section is bent relative to the eighth sub-connecting section and connected with another one of the cable-end connectors, the eighth sub-connecting section is connected with another end of the second extension section.

3. The connector assembly of claim 2, wherein the first extension section is a busbar or a cable bundle, the second extension section is a busbar or a cable bundle.

4. The connector assembly of claim 2, wherein the first extension section of at least one of the first conductive connecting pieces is a busbar, the first extension section of at least another one of the first conductive connecting pieces is a cable bundle.

5. The connector assembly of claim 2, wherein the first sub-connecting section and the fifth sub-connecting section are parallel with each other, the BBC connector comprises a plurality of terminal sets electrically isolated from each other, the first sub-connecting section of one of the first conductive connecting pieces and the fifth sub-connecting section of one of the second conductive connecting pieces are connected with one of the terminal sets, the first sub-connecting section of another one of the first conductive connecting pieces and the fifth sub-connecting section of another one of the second conductive connecting pieces are connected with another one of the terminal sets.

6. The connector assembly of claim 5, wherein the second sub-connecting section of one of the first conductive connecting pieces and the second sub-connecting section of another one of the first conductive connecting pieces are arranged along a first direction, the sixth sub-connecting section of one of the second conductive connecting pieces and the sixth sub-connecting section of another one of the second conductive connecting pieces are arranged along a second direction, the first direction and the second direction are different from each other.

7. The connector assembly of claim 2, wherein the first sub-connecting section and the fifth sub-connecting section are parallel with each other, the BBC connector comprises a plurality of terminal sets electrically isolated from each other, the first sub-connecting section of one of the first conductive connecting pieces and the first sub-connecting section of another one of the first conductive connecting pieces are connected with one of the terminal sets, the fifth sub-connecting section of one of the second conductive connecting pieces and the fifth sub-connecting section of another one of the second conductive connecting pieces are connected with another one of the terminal sets.

8. A cable-end connector, comprising:
a first housing comprising a main shell and an isolation wall, the main shell having an accommodation space, a latching hole, a plurality of first openings and a plurality of second openings, the isolation wall being disposed in the main shell and dividing the accommodation space into two sub-accommodation spaces, the second openings being respectively larger than the first openings, the first openings being opposite to the second openings, each of the sub-accommodation spaces being communicated with one of the first openings and a corresponding one of the second openings;
a plurality of terminals respectively accommodated in one of the sub-accommodation spaces, each of the terminals having a cavity aligned with a corresponding one of the first openings and configured to accommodate a crown spring;
a stopping structure configured to at least partially pass through the latching hole and at least partially interfere with the terminals so as to fix the terminals relative to the first housing; and
a plurality of conductive connecting pieces respectively having a first end and a second end opposite to the first end, the first end being connected with a busbar clip (BBC) connector, the second end being connected with one of the terminals.

9. The cable-end connector of claim 8, wherein each of the terminals further has a latching groove, the stopping structure comprises:
a baffle plate at least partially blocking the second openings;
a U-shaped resilient arm having a fixed end, a free end and a barb portion, the free end being closer to the baffle plate than the fixed end, the barb portion being disposed at the free end;
a cover plate connected with the baffle plate and the fixed end, and configured to abut against the main shell; and
a plurality of latching portions connected with the baffle plate and two opposite sides of the fixed end, the latching portions and the U-shaped resilient arm being configured to at least partially pass through the latching hole, the latching portions being at least partially located in the latching grooves, the U-shaped resilient arm being aligned with the isolation wall, the barb portion latching onto the main shell.

10. The cable-end connector of claim 9, wherein the main shell further has a guiding hole communicated with the latching hole, the stopping structure further comprises:
a guiding strip disposed on a side of the fixed end away from the free end and configured to pass through the guiding hole.

11. The cable-end connector of claim 8, wherein each of the terminals is at least partially recessed on a side away from another one of the terminals to form an abutting surface, the second end passes through a corresponding one of the second openings and at least partially abuts against the abutting surface.

12. A connector assembly, comprising:
a cable-end connector comprising:
a first housing having a plurality of openings, a first side and a second side opposite to the first side, the openings being located at the first side;
a plurality of first terminals configured to be inserted from the second side and at least partially located in the first housing, the first terminals being aligned with the openings;
a plurality of conductive connecting pieces connected with the first terminals; and
a plurality of guiding pins connected with the first housing and extending from the first side, each of the guiding pins having a semi-circular cross-section; and
a board-end connector comprising:
a second housing configured to be mounted on a circuit board;
a structural frame connected outside the second housing and defining a mating space therein, the mating space being configured to at least partially accommodate the first housing, the structural frame having a plurality of guiding grooves communicated with the mating space and configured to accommodate the guiding pins; and
a plurality of second terminals respectively having a central portion, a plug end and a board end, the central portion being located in the second housing, the plug end and the board end respectively protruding outside the second housing, the board end being configured to be electrically connected with the circuit board, the plug end being located in the mating space and configured to pass through one of the openings to electrically connect with a corresponding one of the first terminals.

13. The connector assembly of claim 12, wherein the second housing has a mounting opening located on a side away from the structural frame, the board-end connector further comprises:
a rear cover disposed on the second housing to cover the mounting opening, the rear cover having a plurality of heat dissipation holes.

14. The connector assembly of claim 12, wherein the plug end has a flat surface located on a side away from the central portion.
